(19) United States
(12) Patent Application Publication
(10) Pub. No.: US 2004/0018848 A1
(43) Pub. Date: Jan. 29, 2004

(54) Wireless terminal device, communications system and communications control method

(76) Inventors: Minoru Ogino, Kawasaki-shi (JP); Toshiaki Fujikura, Urayasu-shi (JP); Katsunori Yamamoto, Yachiyo-shi (JP)

Correspondence Address: MCDERMOTT WILL & EMERY, 600 13TH STREET, N.W., WASHINGTON, DC, 20005-3096, US

(21) Appl. No.: 10/280,072

(22) Filed: Oct. 25, 2002

(30) Foreign Application Priority Data
Jul. 26, 2002 (JP) 2002-218629

(51) Int. Cl. H04J 3/00; H04B 7/00; H04Q 7/20

(52) U.S. Cl. 455/519; 455/518; 370/280

(57) ABSTRACT

Provided is a technique to execute stable one-to-N calls in a distributed system without a base station, by solving problems such as overhead due to the switching of the transmission terminal, variations in the combinations of terminals that can communicate with one another, and transmission collisions. The wireless terminal device of this invention operates either as a master station for transmitting data during a first time slot and receiving data during a second time slot, or as a slave station for transmitting data during the second time slot and receiving data during the first time slot. When the wireless terminal device of this invention operates as the master station, it comprises: a first unit for transmitting data input at its own terminal to another terminal; a second unit for, upon receiving data input at another terminal, transmitting the data to another terminal; and a switching unit to exclusively work the first and second units.

### BACKGROUND OF THE INVENTION

1. Field of the Invention

The present invention relates to a communications system for performing peer-to-peer communications between wireless terminal devices without through the medium of a dedicated base station. Particularly, this invention relates to a technique for executing one-to-N calls in the communications system.

2. Description of the Related Art

There are two conventional types of the communications systems such as wireless LAN systems, a distributed type and a centralized type, in which plural wireless terminal devices intercommunicate. A distributed system is a type in which all of the wireless terminal devices perform the peer-to-peer communications. An example of the distributed system is communications between transceivers. A centralized system is a type in which a base station carries out the communications control of mobile stations. For example, communications using the personal handy phones (PHS) and communications with mobile phones fall onto this type. The usage pattern of the communications system and other information are considered to decide which system mode to adopt, thereby providing optimal system designing.

### SUMMARY OF THE INVENTION

With the distributed system that has no base station, one-to-N calls are executed between plural terminals in the structure that: one terminal in a group of terminals becomes a master station (transmission terminal) to carry out transmissions for one-to-N calls; the remaining terminals become slave stations (reception terminals); and the role of the master station is switched between the plural terminals (see FIG. 9).

Upon executing a one-to-N call using the aforementioned conventional structure, there is a problem wherein it is difficult to make a stable one-to-N call for the following reasons: (1) overhead occurs when the master station is switched; (2) since terminals that can communicate with the master station change when the master station is switched, combinations of terminals that can make one-to-N calls do not remain constant; and (3) when the plural terminals in the group are going to take on the role of the master station, conflicts (transmission collisions) may occur.

It is an object of this invention to provide a technique to execute stable one-to-N calls in the distributed system that has no base station, by avoiding the aforementioned problems that occur due to the switching of the transmission terminal.

The wireless terminal device of this invention is characterized in that it comprises: a first unit for transmitting data input at its own terminal to another terminal; a second unit for, upon receiving data input at another terminal, transmitting the data to another terminal; and a switching unit to exclusively work the first and second units.

The wireless terminal device of this invention is also characterized in that it operates either as a master station for transmitting data during a first time slot and receiving data during a second time slot, or as a slave station for transmitting data during the second time slot and receiving data during the first time slot. When the wireless terminal device operates as the master station, it comprises: a first unit for transmitting data input at its own terminal to another terminal; a second unit for, upon receiving data input at another terminal, transmitting the data to another terminal; and a switching unit to exclusively work the first and second units.

It is preferable that the switching unit control the switching between the first unit and the second unit on the basis of a request from another terminal or its own terminal.

It is also preferable that the switching unit control the switching relating to the first unit on the basis of priority information that is set for each wireless terminal device.

It is preferable that the wireless terminal device of this invention perform communications using a TDD method in which one frame has only one communications channel.

In addition, it is preferable that the wireless terminal device of this invention be a device such as a digital transceiver, and that the data include an audio signal.

The communications system of this invention is characterized in that it is a communications system for performing the peer-to-peer communications between wireless terminal devices without through the medium of a dedicated base station. In the communications system, the wireless terminal device comprises: a first unit for transmitting data input at its own terminal to another terminal; a second unit for, upon receiving data input at another terminal, transmitting the data to another terminal; and a switching unit to exclusively work the first and second units.

According to another aspect of this invention, the communications system is characterized in that it is a communications system for performing the peer-to-peer communications between wireless terminal devices without through the medium of a dedicated base station. In the communications system, the wireless terminal device operates either as a master station for transmitting data during a first time slot and receiving data during a second time slot, or as a slave station for transmitting data during the second time slot and receiving data during the first time slot. When the wireless terminal device operates as the master station, the wireless terminal device comprises: a first unit for transmitting data input at its own terminal to another terminal; a second unit for, upon receiving data input at another terminal, transmitting the data to another terminal; and a switching unit to exclusively work the first and second units.

The communications control method for the wireless terminal device of this invention is characterized in that it comprises: a first step of transmitting data input at its own terminal to another terminal; a second step of, upon receiving data input at another terminal, transmitting the data to another terminal; and a step of switching at least between the first and second steps.

The communications control method for the wireless terminal device of this invention is characterized in that it is aimed at a communications system for performing the peer-to-peer communications between wireless terminal devices without through the medium of a dedicated base station. The communications control method comprises the steps of: working a first wireless terminal device as the master station to transmit data during a first time slot and receive data during a second time slot; and working a plurality of wireless terminal devices, except the first wireless terminal device, as slave stations to transmit data during the second time slot and receive data during the first time slot. The step of working the first wireless terminal device as the master station comprises: a first step of transmitting data input at its own terminal to another terminal; a second step of, upon receiving data input at another terminal, transmitting the data to another terminal; and a step of switching at least between the first and second steps.

The program of this invention is characterized in that each step of the communications control method is executed by a computer contained in the wireless terminal device. The program of this invention can be installed or loaded into the computer that is contained in the wireless terminal device, through various recording media such as CD-ROMs, magnetic disks, and semiconductor memories, or through communications networks.

The data transmitted and received between the wireless terminal devices is not limited to audio signals, but may be various modes of data including picture signals.

### BRIEF DESCRIPTION OF THE DRAWINGS

FIG. 1 is a block diagram of the wireless terminal device according to Embodiment 1 of this invention.

FIG. 2 is a diagram explaining the communication sequence to execute the one-to-N call.

FIG. 3 is a diagram explaining the communication sequence to execute the one-to-N call.

FIG. 4 is a diagram explaining the communication sequence to execute the one-to-N call.

FIG. 5 is a timing chart illustrating the system synchronization by the heart-beat method.

FIG. 6 is a diagram showing how the time slots are used when executing the one-to-N call.

FIG. 7 is a diagram showing how the time slots are used when executing the one-to-N call.

FIG. 8 is a diagram showing how the time slots are used when executing the one-to-one call.

FIG. 9 is a diagram explaining the structure of the conventional one-to-N call.

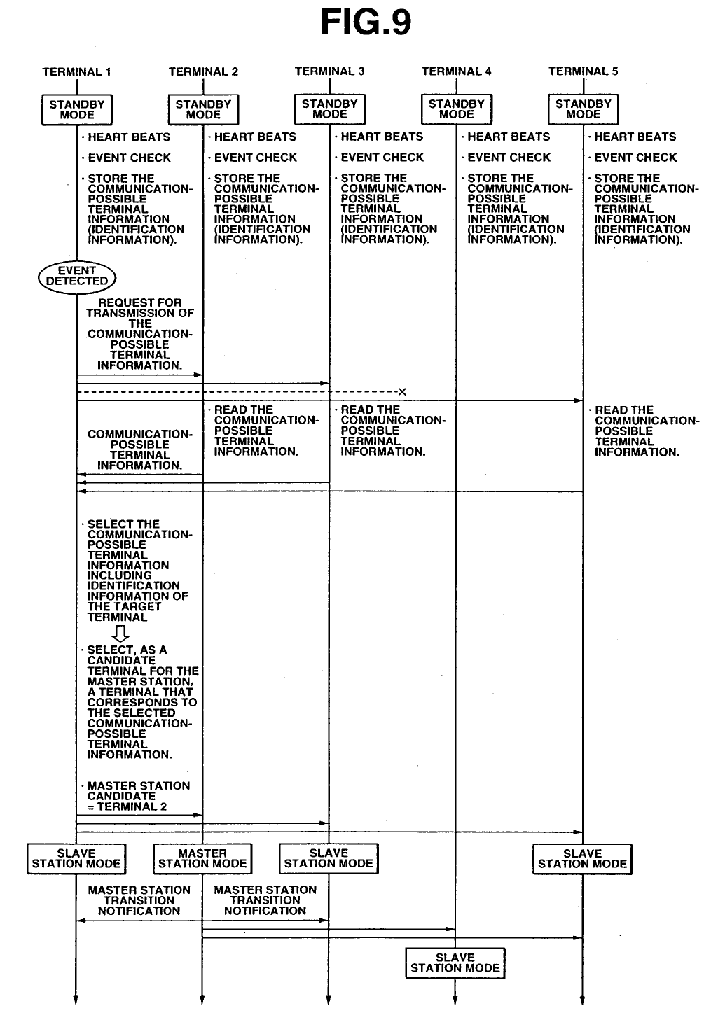

### BEST MODE FOR CARRYING OUT THE INVENTION

(Embodiment 1)

An embodiment of this invention is explained hereinafter with reference to the relevant drawings, by utilizing an example of a communications system that executes the peer-to-peer communications between wireless terminal devices (for example, digital transceivers) without through the medium of a dedicated base station.

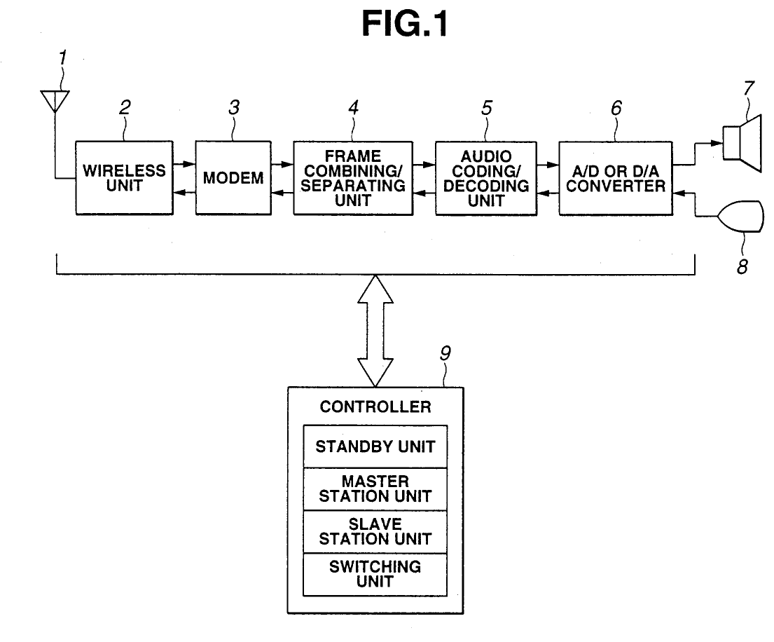

FIG. 1 is a block diagram of the wireless terminal device of Embodiment 1. As shown in FIG. 1, the wireless terminal device includes antenna 1, a wireless unit 2 that is connected to the antenna 1, a modem 3, a frame combining/separating unit 4, an audio coding/decoding unit 5, an A/D or D/A converter 6, a speaker 7, a microphone 8, and a controller 9. In addition to those parts shown in FIG. 1, the wireless terminal device may also comprise constituting elements of which an ordinary wireless device is comprised, for example, an automatic gain controller, an echo canceller, a VOX detector, and an external connection interface.

As a general rule, the structure and operation of each component mentioned above are similar to the structure and operation of a conventional wireless terminal device.

For example, upon transmitting audio signals, the audio signals that have been input from the microphone 8, are converted into digital signals by the A/D or D/A converter 6 under the control of the controller 9. The digital signals are audio-coded by the audio coding/decoding unit 5, and the audio-coded signals are combined into a frame during a transmission time slot by the frame combining/separating unit 4, and the signals are then transmitted to the modem 3. Thereafter, the signals are modulated by the modem 3 under a specified rule. The frequency of the modulated signals is converted into a transmission frequency by the wireless unit 2, and the modulated signals are then transmitted from the antenna 1 to another wireless terminal device.

Upon receiving audio signals, for example, the frequency of the signals received through the antenna 1 is converted by the wireless unit 2 under the control of the controller 9. The signals are demodulated by the modem 3, and are separated from the frame during a reception time slot by the frame combining/separating unit 4. The separated signals are then decoded by the audio coding/decoding unit 5. Thereafter, the signals are converted into analog audio signals by the A/D or D/A converter 6, and are then output as sounds from the speaker 7.

It is possible to decide which signal transmission method to be adopted for the wireless terminal device of this embodiment, in accordance with the design of the wireless terminal device. Hereinafter, an explanation is given, assuming that communications are made in the Time Division Duplex (TDD) method wherein one frame, which is a unit for transmitting or receiving the audio signals, has only one communications channel, that is, two time slots (a first slot and a second slot).

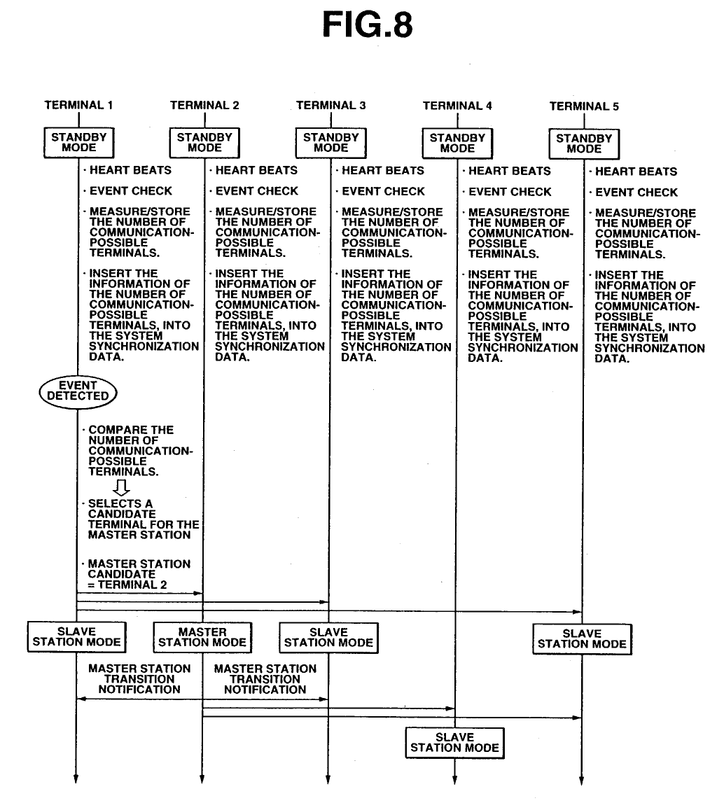

The wireless terminal device according to Embodiment 1 has the function to execute one-to-one calls by the TDD method. For example, upon executing one-to-one calls between a terminal 1 and a terminal 2, the terminal 1 uses a channel, that was decided between the terminals in advance, to transmit a calling signal to the terminal 2 during the first slot in order to establish a wireless link therebetween. On the other hand, the terminal 2 monitors the signal on the channel, and when it detects the calling signal, it receives it. When it is possible to make a call, the terminal 2 returns a response signal indicating the availability to the terminal 1 during the second slot. Subsequently, the first slot is used to transmit the audio signals from the terminal 1 to the terminal 2, and the second slot is used to transmit the audio signals from the terminal 2 to the terminal 1 (see FIG. 8), thereby executing the one-to-one calls.

Moreover, the wireless terminal device according to Embodiment 1 has the function to execute one-to-N calls by the TDD method.

As for operation modes for one-to-N calls, the wireless terminal device according to Embodiment 1 is capable of operating in any one of the following modes: a standby mode; a master station transmission mode; a master station reception/repetition mode; a slave station transmission mode; and a slave station reception mode. The wireless terminal device stores programs, such as a program having the operational procedures in the respective modes mentioned above, and a program for switching the operation modes (a program for controlling each mode to operate exclusively). The controller 9 executes each program, thereby realizing operations in each mode and switching operations on the wireless terminal device. FIG. 1 shows the operations in each mode and the switching operations, which are respectively construed as functioning units.

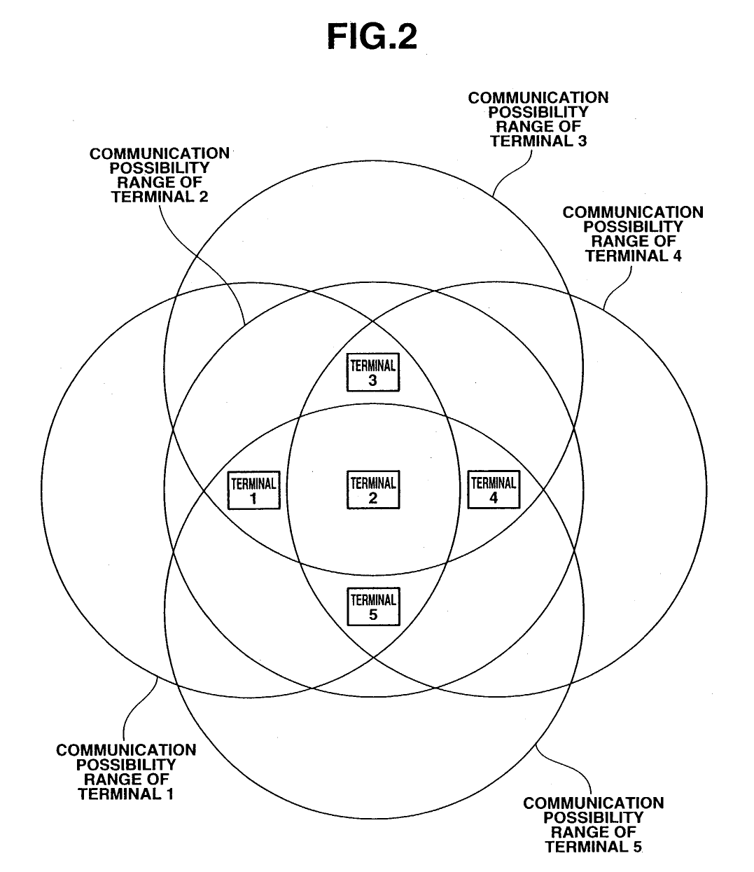

Hereinafter, the operations of each wireless terminal device upon executing one-to-N calls, are explained in detail with reference to FIGS. 2 to 7, by showing an example case in which three wireless terminal devices form a group to execute the one-to-N calls. It is also possible to execute the one-to-N calls by forming plural groups at the same time, using different channels, and providing master stations in the respective groups.

(Standby State: FIG. 2(a))

When, for example, a specified event (such as key input) is detected, the wireless terminal device begins operating in standby mode.

While operating in standby mode, each wireless terminal device monitors a channel, which was decided in advance between the terminals for execution of the one-to-N calls, while obtaining system synchronization using heart beats, and waits for a one-to-N call to begin.

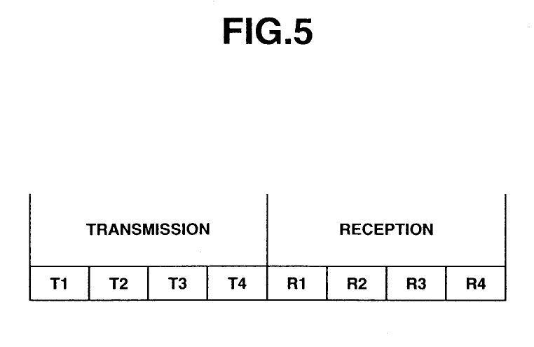

FIG. 5 is a timing chart for system synchronization using heart beats. As shown in FIG. 5, P1 represents a full cycle and P2, a basic cycle, represents a fixed transmission period for each terminal device. Settings are employed so that the terminal devices 1 to 3 take turns to become a transmission terminal. Specifically, in cycle 1, the terminal device 1 is a transmission terminal, while the terminal devices 2 and 3 are reception terminals. In the next cycle 2, the terminal device 2 is the transmission terminal, while the terminal devices 1 and 3 are the reception terminals. When each terminal device is undergoing the cycle where it functions as the reception terminal, it receives data from the transmission terminal and adjusts the reception cycle (reception timing) on the basis of the data. Thus, when using the heart-beat method, system synchronization is not obtained through a fixed standard station, but each terminal device takes turns to become the standard station. Accordingly, each wireless terminal device is able to respond to an ever-changing wireless environment.

(Commencement of a One-to-N Call: FIG. 2(b))

In Embodiment 1, a wireless terminal device that operates as a master station is not fixed and any wireless terminal device operating in standby mode can transfer its mode to master station mode. However, among the plural wireless terminal devices executing one-to-N calls, only one wireless terminal device can operate in master station mode. The rest of the wireless terminal devices operate as slave stations.

The description assumes that the terminal 1 operating in standby mode detects a specified event (for example, a key input or an audio input form the microphone 8) that indicates the commencement of a one-to-N call. In this case, the terminal 1 transmits to the terminals 2 and 3 a request to begin a one-to-N call during the first slot of the aforementioned channel, and switches from standby mode to master station transmission mode.

The terminals 2 and 3 receive the request from the terminal 1 to start a one-to-N call, and switch from standby mode to slave station reception mode.

(A One-to-N Call from the Master Station to the Slave Stations: FIG. 2(c))

When the audio signal is input at the terminal 1 which is operating in master station transmission mode, the terminal 1 transmits the audio signal during the first slot.

The terminals 2 and 3 which are operating in slave station reception mode, monitor the first slot, and upon receiving the audio signal from the terminal 1, they output the audio signal from the speaker 7.

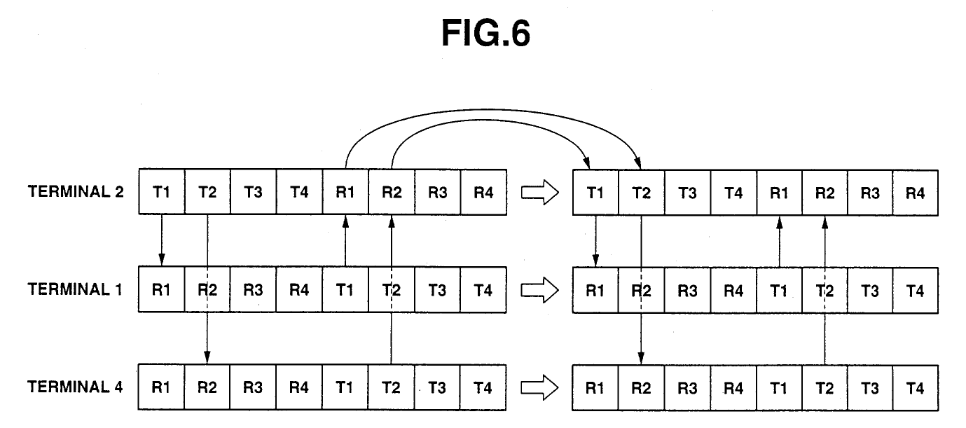

Through this series of operations, one-to-N calls can be executed from the master station (the terminal 1) to the slave station (the terminals 2 and 3). FIG. 6 shows how the time slots are used for the above case.

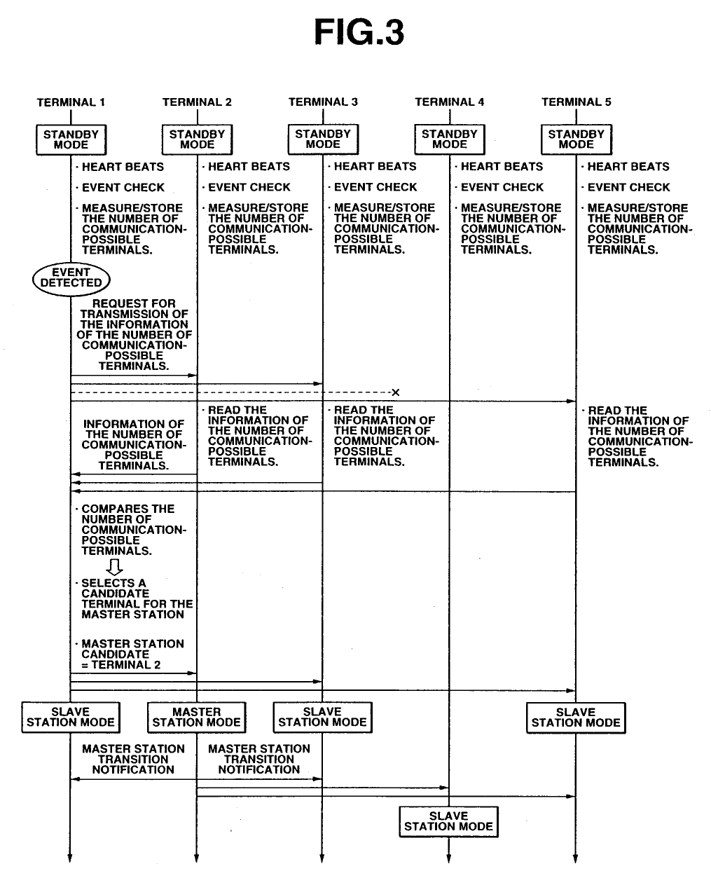

(Switching from the Master Station Transmission Mode to the Master Station Reception/Repetition Mode: FIG. 3(a))

The terminals 2 and 3 operating in slave station reception mode, check whether or not there is a specified event (for example, a key input or an audio input from the microphone 8) that indicates the commencement of the slave station transmission mode. A conventional technique, such as VOX detection, can be employed to detect audio inputs.

It is assumed that the terminal 2 detects the specified event that indicates the commencement of the slave station transmission mode. In this case, the terminal 2 transmits to the terminal 1 during the second slot a request to begin the slave station transmission mode.

The terminal 1 that is operating in the master station transmission mode monitors the second slot. When the terminal 1 receives the request from the terminal 2 to begin the slave station transmission mode, it switches from master station transmission mode to master station reception/repetition mode, and transmits the notification to commence repetition mode to the terminals 2 during the first slot. This notification to commence repetition mode may be the request to begin the slave station transmission mode that is transmitted from the terminal 2. A structure may be adopted where the terminal 1 uses a display device, such as an LCD, to display that the terminal 2 is in slave station transmission mode.

While the terminal 2 is operating in slave station reception mode, it monitors the first slot. Upon receiving from the terminal 1 the notification to commence repetition mode, it interprets that the request it made to begin transmission mode has been permitted by the terminal 1 which is operating as the master station, and switches from slave station reception mode to slave station transmission mode.

While the terminal 3 is operating in the slave station reception mode, it monitors the first slot. When the terminal 3 receives the notification to commence the repetition mode from the terminal 1, it interprets that another terminal has begun to operate in slave station transmission mode. Then, in order not to cause conflicts between the terminals by switching its mode to slave station transmission mode, it either stops checking the specified event that indicates the commencement of slave station transmission mode, or refrains from transmitting the request to the terminal 1 to start the transmission mode even if it has detected such an event. The notification to commence repetition mode may include information showing that the terminal that has requested the commencement of slave station transmission mode is the terminal 2. In this case, a structure may be adopted where the terminal 3 uses a display device, such as an LCD, to display that the terminal 2 is in slave station transmission mode.

Through the aforementioned series of operations, the operation modes of the respective terminals are switched as necessary in order for the one-to-N call to proceed into the state in which a call is made from the slave station (the terminal 2) to the master station (the terminal 1) or to the other slave station (the terminal 3).

(A One-to-N Call from the Slave Station to the Master Station and the Other Slave Station: FIG. 3(b))

When the audio signal is inputted at the terminal 2 operating in slave station transmission mode, it transmits the audio signal to the terminal 1 during the second slot. While operating in slave station transmission mode, the terminal 2 may stop monitoring the first slot (reception mute) or the speaker 7 may be put in the mute state.

The terminal 1 operating in master station reception/repetition mode, monitors the second slot. When the terminal 1 receives the audio signal from the terminal 2, it outputs the received audio signal from the speaker 7. The terminal 1 also transmits the received audio signal during the first slot. At this time, it is preferable that the received audio signal is directly transmitted during the first slot, without being processed, in order to prevent deterioration of the sound quality that may be caused by processing.

The terminal 3 operating in slave station reception mode, monitors the first slot. When the terminal 3 receives the audio signal from the terminal 1 (i.e. the audio signal input at the terminal 2), it outputs the audio signal from the speaker 7.

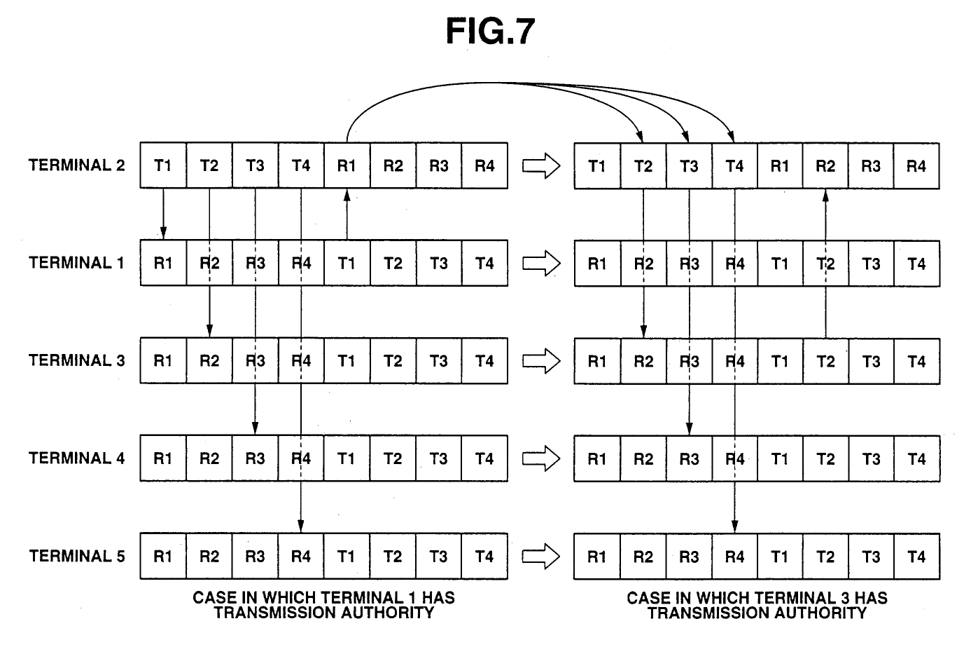

Through this series of operations, a call is conveyed from the terminal 2 to the terminal 1 and then to the terminal 3 through the terminal 1. As a result, a one-to-N call is made from the slave station (the terminal 2) to the master station (the terminal 1) and the other slave station (the terminal 3) FIG. 7 shows how the time slots are used in this case.

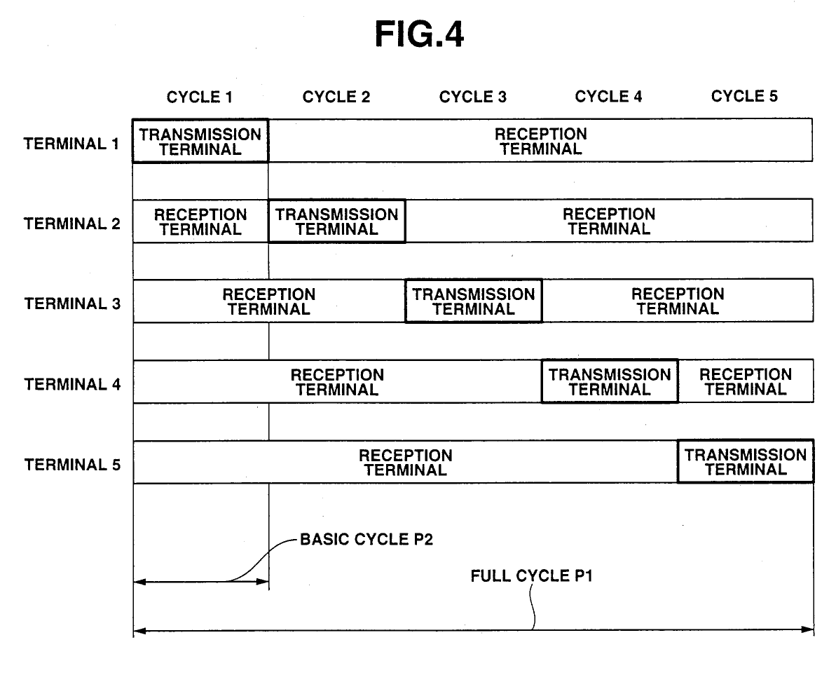

(Switching from Master Station Reception/Repetition Mode to Master Station Transmission Mode: FIG. 4(a))

The terminal 2 operating in slave station transmission mode, checks whether or not a specified event (for example, a key input or no detection of sounds from the microphone 8) that indicates termination of slave station transmission mode, has occurred.

It is assumed that the terminal 2 detects the specified event that indicates termination of slave station transmission mode. In this case, the terminal 2 transmits a request to the terminal 1 to terminate slave station transmission mode during the second slot.

The terminal 1 operating in the master station reception/repetition mode, monitors the second slot. When the terminal 1 receives the request from the terminal 2 to terminate slave station transmission mode, it switches from master station reception/repetition mode to master station transmission mode and transmits the notification to terminate repetition mode to the terminals 2 and 3 during the first slot. This notification to terminate repetition mode may be the request from the terminal 2 to terminate slave station transmission mode.

The terminal 2 operating in slave station transmission mode, monitors the first slot. When the terminal 2 receives the notification to terminate repetition mode from the terminal 1, it interprets that its request to terminate the transmission mode has been permitted by the terminal 1, and switches from slave station transmission mode to slave station reception mode. If reception mute has been selected while operating in slave station transmission mode, a structure may be adopted so that reception is resumed when the request to terminate slave station transmission mode has been transmitted.

The terminal 3 operating in slave station reception mode, monitors the first slot. When the terminal 3 receives the notification to terminate repetition mode from the terminal 1, it interprets that slave station transmission mode has been terminated at another terminal, and resumes a processing such as an event check that had previously been suspended.

Through the aforementioned series of operations, the operation modes of the respective terminals are switched as necessary in order for the one-to-N call to proceed into a state in which a call is again made from the master station to the slave stations.

(Termination of a One-to-N Call: FIG. 4(b))

The terminal 1 operating in the master station transmission mode, checks whether or not a specified event (for example, a key input) that indicates termination of a one-to-N call, has occurred. When the terminal 1 detects such an event, it transmits a request to the terminals 2 and 3 to terminate the one-to-N call during the first slot, and switches from master station transmission mode to standby mode.

The terminals 2 and 3 receive the request from the terminal 1 to terminate the one-to-N call, and switch from slave station reception mode to standby mode.

Accordingly, the respective terminals proceed to the standby state, and wait for a one-to-N call to commence.

With the structure of Embodiment 1, only the master station (the terminal 1 in the above explanation) can transmit the audio signal during the first slot; therefore, there are no conflicts regarding the use of the first slot. In other words, the first slot functions as a transmission-only slot for the master station (the terminal 1), and the slave stations (the terminals 2 and 3 in the above explanation) can use the first slot as a reception-only slot.

In Embodiment 1, during one-to-N calls (from beginning to end), the wireless terminal device that operates as the master station is not switched. Instead, modes of the respective wireless terminal devices are switched, thereby, executing one-to-N calls. Accordingly, problems of the related art, such as overhead upon switching the master station and changes in the combinations of terminals that can communicate upon switching the master station, will not occur. Moreover, there are no conflicts between the terminals to take on the role of the master station (transmission collisions) during the execution of one-to-N calls. Therefore, stable one-to-N calls can be executed.

Furthermore, in Embodiment 1, one-to-N calls can be executed using the TDD method in which one frame has one communications channel, that is, two time slots (the first slot and the second slot). Accordingly, when compared with the Time Division Multiple Access (TDMA) method using a multi-slot that requires communications control at hit bit rate, one-to-N calls using the TDD method has advantages such as: (1) cost-cutting with regard to devices and the like; (2) extension of distances between the terminals that can communicate with one another while maintaining the communication quality; and that (3) the number of terminals executing one-to-N calls is not limited to the number of the time slots. As a result, it is possible to construct a highly versatile communications system.

(Variation)

In the structure of Embodiment 1, one-to-N calls are executed without switching the master station; therefore, there are no conflicts regarding the master station during the execution of one-to-N calls. However, upon starting a one-to-N call, if plural wireless terminal devices simultaneously request to commence a one-to-N call, there is a possibility that a conflict regarding a master station will arise. In order to solve this problem, it is conceivable to modify the structure in Embodiment 1 by setting priorities to the respective wireless terminal devices in order to avoid conflicts on the basis of the priorities.

For example, a wireless terminal device that has transmitted a request to start a one-to-N call, remains in the standby mode for a specified period of time (for example, a full cycle of heart beats). During the specified period, if the terminal receives another request to start a one-to-N call from another wireless terminal device having a higher priority compared with its own priority, it gives precedence to another wireless terminal device and causes its own terminal to switch from standby mode to slave station reception mode. On the other hand, if the wireless terminal device receives a request to start a one-to-N call from a wireless terminal device having a lower priority compared with its own priority, when it detects a specified event that indicates the commencement of a one-to-N call in the specified period of time, it takes priority over the other terminals, transmits the request to other wireless terminal devices, and switches from standby mode to master station transmission mode. Thus, by constructing the mode switching operations as described above, it is possible to avoid conflicts upon starting a one-to-N call. A terminal number of a wireless terminal device may be used as an indication of priority.

(Others)

As another embodiment of this invention, a recording medium having an information processing program recorded thereon may be conceived. Examples of the recording media to be used may include a CD-ROM, a magnetic disk, a semiconductor memory, and other recording media.

A data processor reads the information processing program on the recording medium, and the program controls the operations of the data processing device. Under the control of the information processing program, the data processor realizes each operation mode and switching thereof in the one-to-N call between the wireless terminal devices in Embodiment 1.

This invention can be applied in various modifications and is not limited to the above embodiments.

For example, in Embodiment 1, the operation mode of the master station is switched on the basis of a request from a slave station. However, this invention shall not be limited to this structure. For example, a structure may be adopted where the master station forces itself to switch from master station reception/repetition mode to master station transmission mode. In this case, it is preferable that a terminal operating in slave station transmission mode continue monitoring the first slot so that it can receive a compulsory notification to terminate repetition mode from the master station.

Moreover, one-to-N calls may be made by combining the structure of Embodiment 1 wherein calls are executed without switching the master station, with the conventional structure wherein the master station is switched to execute one-to-N calls.

Furthermore, although Embodiment 1 employs the TDD method to executing one-to-N calls, it is also possible to make calls by adopting Frequency Division Duplex (FDD) method in the structure in Embodiment 1.

Finally, Embodiment 1 explains this invention by using the example of the communication system that consists of plural wireless terminal devices such as transceivers. However, this invention shall not be limited to such system. For example, this invention can also be applied to the wireless network such as the wireless LAN, as well as to communications systems where terminal devices are home electric appliances comprising data communications functions, for example, a video player, an audio system, a TV monitor, and a personal computer.

According to this invention, a distributed system having no base station, can execute stable one-to-N calls while avoiding problems that arise due to switching the transmission terminal.

The entire disclosure of Japanese Patent Application No. 2002-218629 filed on Jul. 26, 2002 including specification, claims, drawings and summary are incorporated herein by reference in its entirety.

What is claimed is:

1. A wireless terminal device comprising:
a first unit for transmitting data input at its own terminal to another terminal;
a second unit for, upon receiving data input at another terminal, transmitting the data to another terminal; and
a switching unit to exclusively work the first and second units.

2. A wireless terminal device for operating either as a master station for transmitting data during a first time slot and receiving data during a second time slot, or as a slave station for transmitting data during the second time slot and receiving data during the first time slot,
wherein when the wireless terminal device operates as the master station, it comprises:
a first unit for transmitting data input at its own terminal to another terminal;
a second unit for, upon receiving data input at another terminal, transmitting the data to another terminal; and
a switching unit to exclusively work the first and second units.

3. The wireless terminal device according to claim 1 or 2, wherein the switching unit controls the switching between the first unit and the second unit on the basis of a request from another terminal or its own terminal.

4. The wireless terminal device according to claim 1 or 2, wherein it performs communications using a TDD method in which one frame has only one communications channel.

5. The wireless terminal device according to claim 1 or 2, wherein the data includes an audio signal.

6. The wireless terminal device according to claim 1 or 2, wherein the switching unit controls the switching relating to the first unit on the basis of priority information that is set for each wireless terminal device.

7. A communications system for performing peer-to-peer communications between wireless terminal devices without through the medium of a dedicated base station,
wherein the wireless terminal device comprises:
a first unit for transmitting data input at its own terminal to another terminal;
a second unit for, upon receiving data input at another terminal, transmitting the data to another terminal; and
a switching unit to exclusively work the first and second units.

8. A communications system for performing peer-to-peer communications between wireless terminal devices without through the medium of a dedicated base station,
wherein the wireless terminal device operates either as a master station for transmitting data during a first time slot and receiving data during a second time slot, or as a slave station for transmitting data during the second time slot and receiving data during the first time slot, and
wherein when the wireless terminal device operates as the master station, the wireless terminal device comprises:
a first unit for transmitting data input at its own terminal to another terminal;
a second unit for, upon receiving data input at another terminal, transmitting the data to another terminal; and
a switching unit to exclusively work the first and second units.

9. A communications control method for a wireless terminal device, comprising:
a first step of transmitting data input at its own terminal to another terminal;
a second step of, upon receiving data input at another terminal, transmitting the data to another terminal; and
a step of switching at least between the first and second steps.

10. A communications control method aimed at a communications system to perform peer-to-peer communications between wireless terminal devices without through the medium of a dedicated base station, comprising the steps of:
working a first wireless terminal device as a master station to transmit data during a first time slot and receive data during a second time slot; and
working a plurality of wireless terminal devices except the first wireless terminal device, as slave stations to transmit data during the second time slot and receive data during the first time slot,
wherein the step of working the first wireless terminal device as the master station comprises:
a first step of transmitting data input at its own terminal to another terminal;
a second step of upon receiving data input at another terminal, transmitting the data to another terminal; and
a step of switching at least between the first and second steps.

11. A program for making a computer contained in a wireless terminal device execute the communications control method according to claim 9 or 10.
